(19) United States
(12) Patent Application Publication
(10) Pub. No.: US 2004/0264208 A1
(43) Pub. Date: Dec. 30, 2004

(54) Headlamp for automobiles

(75) Inventor: Takaaki Nishizawa, Shizuoka-shi (JP)

Correspondence Address: KODA & ANDROLIA, 2029 CENTURY PARK EAST, SUITE 1430, LOS ANGELES, CA, 90067-3024, US

(73) Assignee: Koito Manufacturing Co., Ltd.

(21) Appl. No.: 10/865,338

(22) Filed: Jun. 10, 2004

(30) Foreign Application Priority Data
Jun. 27, 2003 (JP) 2003-184875

(51) Int. Cl. F 21W 1 1/10

(52) U.S. Cl. 362/514

(57) ABSTRACT

A headlamp for an automobile including: a container-shaped lamp body that forms, together with a front cover mounted on the front opening of the lamp body, a lamp chamber; a reflector that has a light source and is tiltable around a predetermined horizontal tilt axis inside the upper portion of the lamp chamber; and a leveling actuator that is provided on the outside bottom of the lamp body and has an actuation shaft movable in the back and forward direction of the lamp body and connected to the reflector.

### BACKGROUND OF THE INVENTION

1. Field of the Invention

The present invention relates to a headlamp for automobiles in which a reflector, which is inside the lamp chamber and has a light source, is tiltable around a horizontal tilt axis by a leveling actuator provided outside the lamp body

2. Prior Art

In the headlamp for an automobile, a reflector that has a light source is accommodated inside a lamp chamber defined by a lamp body and a front cover, and the light distribution of the low beam formed by the reflector is set so that the optical axis of the headlamp (or of the reflector) has a certain downward inclination with respect to the vehicle axis so that the driver has a good forward visibility and a glare with respect to a car coming from the opposite direction is prevented.

However, it occasionally happens that the vehicle front portion lifts up or settles down in accordance with, for instance, acceleration and deceleration of the vehicle, so that the inclination of the axis (the optical axis of the lamp) changes upward and downward with respect to the road surface. This would decrease the forward visibility of the driver and apply glare to the car coming from the opposite direction, thus hindering safety drive.

One solution of the above problem is shown in Japanese Patent No. 2835927.

As seen from FIG. 7, in this conventional lamp structure, a reflector 3 that has a light source (not shown) is provided so that it can tilt around a horizontal tilt axis (not shown) inside the lamp chamber S defined by a lamp body 1 and a front cover 2, and the actuation shaft 4a of a leveling actuator 4 provided in the back of the lamp body 1 is coupled to the reflector 3 via a nut 5. The actuator 4 is operated by a detection signal of an axis tilt sensor (not shown) provided in the vehicle body so that the output of the sensor is kept constant, thus allowing the adjustment of the optical axis of the lamp to be made at a proper position (a fixed tile position with respect to a running road surface) in real time.

A leveling actuator that operates to tilt a reflector in which, as shown in FIG. 7, the actuation shaft 4a is movable forward and backward in its axial direction is disclosed in Japanese Patent Application Laid-Open (Kokai) No. 2001-97107.

However, in the conventional headlamp described above, the actuator 4 protrudes to the back of the lamp body 1. Accordingly, the depth of the lamp is large to that degree, and thus it is impossible to sufficiently respond to the recent demand of making the headlamp thinner.

In view of the above, the inventor of the present application conceived an idea to install the actuator 4 inside the lamp chamber. However, since the actuator 4 involves a motor which is an electric component, it is undesirable to provide the actuator 4 inside the lamp chamber S that becomes high in temperature when the lamp is lit. Then, the inventor conceived an idea to install the actuator 4 in the bottom side of the lamp body 1 where installation of the actuator causes no hindrance. However, when the actuator 4 is provided in the bottom side of the lamp body 1, then it becomes extremely difficult to couple the actuator to the reflector provided in the back of the inside of the lamp chamber so that the reflector can tilt. Accordingly, the inventor conceived an idea in which it would be possible to couple the reflector so as to tilt by contriving the arranging direction of the actuator or contriving the extending direction of the actuation shaft of the actuator and created the present invention.

### SUMMARY OF THE INVENTION

The present invention is made in the light of the problems in the prior art described above, and the object of the present invention is to make it possible to design an automobile headlamp thinner by way of not providing a leveling actuator in the back side of a lamp body.

The above object is accomplished by a unique structure of the present invention for a headlamp for an automobile which includes a container-shaped lamp body that forms a lamp chamber in cooperation with a front cover fitted to the front opening of the lamp body, a reflector that has a light source and is provided so as to freely tilt around a predetermined horizontal tilt axis in the inside upper portion of the lamp chamber, and a leveling actuator that is inserted and attached from the outside to an installation hole of the lamp body and is equipped with an actuation shaft movable forward and backward and connected to the reflector inside the lamp chamber; and in the present invention, the actuator is installed in the bottom portion of the lamp body.

Since the leveling actuator is provided in the bottom portion of the lamp body, it does not protrude to the back of the lamp body, and thus the headlamp can be smaller in depth to that degree.

In the above structure, an actuator accommodating recess portion is formed in the bottom wall of the lamp body so as to inwardly protrudes toward the lamp chamber, the installation hole is provided in a substantially vertical area that extends to the right and left sides of a wall portion of the recess portion, and the actuator is inserted and attached to the installation hole from the recess portion side so that an actuation shaft of the actuator extends to the rear side within the lamp chamber.

The leveling actuator is installed in the recess portion which is provided in the bottom wall of the lamp body so as to inwardly protrude to the lamp chamber side, and thus the leveling actuator does not protrude largely to the lower side of the lamp body.

In addition, in the structure of the headlamp of the present invention, the installation hole is provided in the bottom wall of the lamp body, the actuator is inserted and attached to the installation hole from the lower side of the lamp body, an actuation force transmission member and the actuation shaft can be set to protrude to the upper side of the installation hole in substantially L shape, and the actuation shaft of the actuator extends to the front side or rear side of the inside of the lamp chamber.

Since the leveling actuator does not protrude largely inside the lamp chamber, it does not cause any hindrance to other functions. In addition, it is possible to mount and dismount the leveling actuator from the lower side of the lamp body.

### BRIEF DESCRIPTION OF THE DRAWINGS

FIG. 1 is a front elevational view of the headlamp for an automobile in accordance with the first embodiment of the present invention;

FIG. 2 is a vertical cross-sectional view of the headlamp taken along the line II-II in FIG. 1;

FIG. 3 shows in vertical cross-section a modified headlamp of the first embodiment;

FIG. 4 is a front elevational view of the headlamp for an automobile in accordance with the second embodiment of the present invention;

FIG. 5 is a vertical cross-sectional view of the headlamp taken along the line IV-IV of FIG. 4;

FIG. 6 shows in vertical cross-section a modified headlamp of the second embodiment; and

FIG. 7 is a vertical cross-sectional view of a conventional headlamp for an automobile.

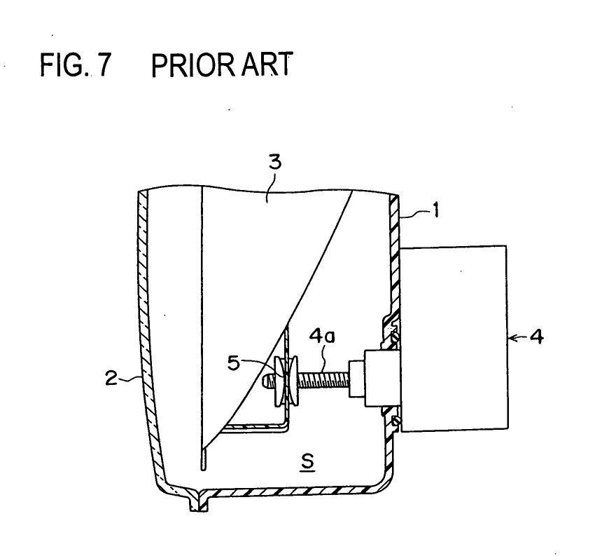

### DETAILED DESCRIPTION OF THE INVENTION

Hereafter, embodiments of the present invention will be described in accordance with the accompanying drawings.

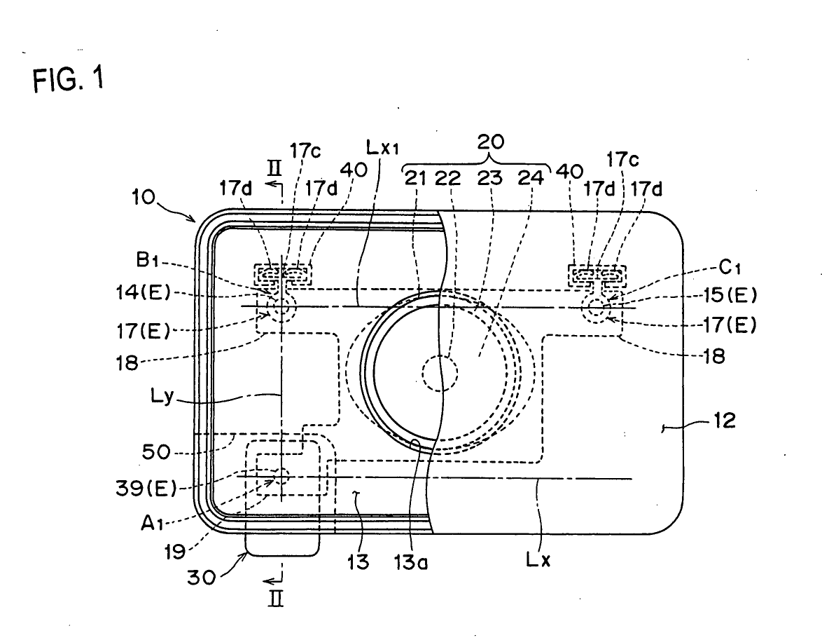

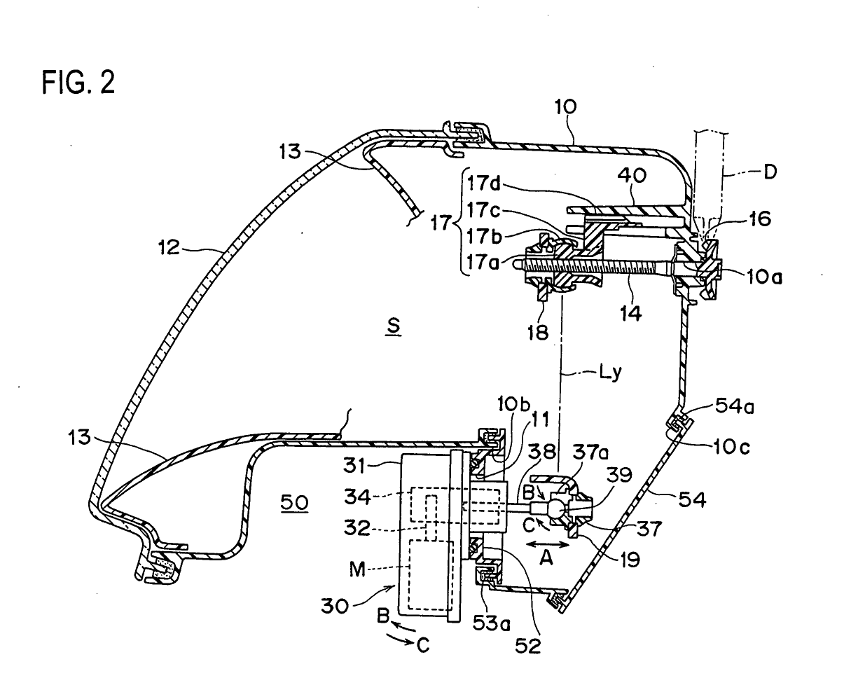

In FIGS. 1 and 2, the reference numeral 10 denotes a synthetic resin container-shaped lamp body that opens the front side. A clear front cover 12 is fitted on the front opening of the lamp body 10, thus forming a lamp chamber S with the lamp body 10 and front cover 12. A low-beam forming projection type light source unit 20 is accommodated inside the lamp body 10, that is, inside the lamp chamber S. The light source unit 20 is integrally formed with a projection lens 24 via a lens holder 23 in the front side of a substantially oval reflector 21 in which a discharge bulb 22 is, as its light source, inserted and attached to the rear top portion.

An aluminum vapor deposition treatment is applied to the front surface of the reflector 21. The discharge bulb 22 is provided on the first focal point of the reflector 21, and a shade (not shown) for forming a clear cut line is provided vertically at a position near the lens focal point between the projection lens 24 and the reflector 21. With the structure described above, a low beam that has a predetermined clear cut line in correspondence to the upper edge of the shade is formed in a projection manner in front of the vehicle by the light source unit 20.

The projection type light source unit 20 is supported by three points comprised of a pair of aiming points B₁ and C₁, which are apart from each other in the lateral direction in the upper inside of the lamp chamber S, and one aiming support point A₁, which is positioned just below the aiming point B₁; and thus the projection type light source unit 20 is tiltable by aiming mechanism E described below around a horizontal tilt axis Lx and a vertical tilt axis Ly. Here; the horizontal tilt axis Lx is parallel to the axis Lx₁, which passes through the aiming points B₁ and C₁, and passes through the aiming support point A₁; and the vertical tilt axis Ly passes through the aiming points B₁ and A₁,

More specifically, rear end portions of two aiming screws 14 and 15 that extend forward are rotatably supported by the back surface wall of the lamp body 10, and a bevel gear 16 is integrally formed with each one of the rear end portions of the aiming screws 14 and 15 which extends through the back surface wall (or through a screw insertion hole 10a) of the lamp body 10. On the other hand, a pair of brackets 18 to which bearing nuts 17 screwed on the aiming screws 14 and 15 are inserted and attached are formed in the upper portion of the light source unit 20 (the reflector 21) so as to extend to the outside in the lateral direction. Each of the bearing nuts 17 is constituted by a pivot 17a, which is a nut portion screwed with the aiming screw 14 (15), and a bearing 17b, which is inserted and attached to the bracket 18 and rotatably supports the pivot 17a. In the lower portion of the light source unit 20 (the reflector 21), a bracket 19 is provided. The bracket 19 has a bearing 37 which is coupled to and supports a pivot portion 39 provided at the end of an actuation shaft 38 of a leveling actuator 30 described below.

With the structure described above, as seen from FIG. 2, when the aiming screws 14 and 15 are, with a tip end of a screw driver D engaged with the bevel gear 16, rotated an approximately the same amount, the bearing nuts 17 move forward and backward along the aiming screws 14 and 15, the light source unit 20 (the reflector 21) tilts around the horizontal tilt axis Lx, and the optical axis of the light source unit 20 tilts in the vertical direction. On the other hand, when only the aiming screw 15 is rotated by the screw driver D, the bearing nut 17 screwed on the aiming screw 15 moves forward and backward, and the light source unit 20 (the reflector 21) tilts around the vertical tilt axis Ly, and thus the optical axis of the light source unit 20 tilts in the lateral direction.

As seen from the above, the aiming mechanism E for tilting and adjusting the optical axis of the light source unit 20 (the reflector 21) in the vertical and lateral directions is structured by a pair of aiming screws 14 and 15, the bearing nuts 17 that form the aiming points B₁ and C₁ screwed on the aiming screws 14 and 15, and the pivot portion 39 that forms the aiming support point A₁.

Each reference numeral 17c denotes a slide arm which is T-shaped when seen from the front and is integrally formed with the bearing 17b of the bearing nut 17. A pair of tongue-shaped leaf springs 17d and 17d are provided in the slide portion that is at an upper end of the slide arm 17c, and the slide portion of the slide arm 17c is provided slidably in a dovetail groove guide 40 which extends to the front side along the aiming screws 14 and 15 from the back surface wall of the lamp body 10. In other words, since the projection type light source unit 20 has quite a bit of weight because the projection lens 24 is made of glass, the load of such heavy light source unit 20 is applied to the aiming mechanism E. In view of this, the aiming screws 14 and 15 are provided so that they are, at their end portions, supported by the guide 40; as a result of this structure, the aiming screws 14 and 15 are prevented from being deformed (hanging down), and an unexpected excessive stress is avoided from being applied to the peripheral edge portion of the screw insertion holes 10a provided in the back surface wall of the lamp body 10. A long time use of the aiming mechanism E is thus secured.

The leveling actuator 30 is of such a publicly known structure as disclosed in, for example, Japanese Patent Application Laid-Open (Kokai) No.2001-97107. More specifically, the leveling actuator 30 is structured so that when the output shaft 32 of a motor M inside the actuator housing 31 is rotated, the actuation shaft 38 provided in orthogonal to the output shaft 32 in the axial direction is moved forward and backward by the gear mechanism 34 that is comprised of a worm, a worm wheel and the like (not shown). In addition, an actuator accommodating recess portion 50 that is formed so as to inwardly protrude to the lamp chamber S side is provided in a part (a left corner portion when the lamp is viewed from the front or in the direction of FIG. 1) of the lamp body bottom wall, and the actuator 30 is installed inside this recess portion 50. The actuation shaft 38, that is movable forward and backward, extends into the rear portion of the lamp chamber S through the actuator installation hole 11 which is provided in the laterally extending substantially vertical wall 52 of the recess portion 50; and the actuation shaft 38 has at its tip end the pivot portion 39 which engages with the bearing 37 provided in the bracket 19 of the light source unit 20 (the reflector 21).

In this leveling actuator 30, the actuation shaft 38 moves forward and backward in the longitudinal direction (in a direction of arrow A in FIG. 2) in accordance with the operation of the motor M and tilts the light source unit 20 (the reflector 21) around the horizontal tilt axis Lx1. Thus, the leveling actuator 30 forms an automatic leveling apparatus that tilts the optical axis of the light source unit 20 (the reflector 21) in the vertical direction. The optical axis of the headlamp can be adjusted to be a proper position in several different ways. In one method, a correlation between the deadweight of the automobile and a tilt amount of the optical axis of the headlamp in the vertical direction is stored beforehand in a control section (not shown) that controls the operation of the actuator 30 (the motor M), and the automatic leveling apparatus is operated (or a control of the operation of the motor M of the actuator 30 is done) in accordance with the deadweight detected by a deadweight detecting sensor provided in the vehicle body. In another method, a correlation between the tilt amount of the axle in the automobile with respect to the running road surface and the tilt amount of the optical axis of the headlamp in the vertical direction is stored beforehand in a control section (not shown) that controls the operation of the actuator 30, and the automatic leveling apparatus is operated (a control of the operation of the motor M of the actuator 30 is done) in accordance with the tilt amount of the vehicles' axis detected by an axle tilt detecting sensor provided in the vehicle body

The pivot portion 39 at the end of the actuation shaft 38 and the bearing 37 of the bracket 19 can be easily engaged and disengaged with each other via a pivot introduction portion 37a of the bearing 37 by moving the actuator 30 back and forth in the direction of arrows B and C in FIG. 2.

In other words, when the actuator 30 is to be installed, the pivot portion 39 is first put into the bearing 37 by holding the light source unit 20 (the reflector 21) supported by the aiming screws 14 and 15 by pressing it by, for example, the left hand, and the actuation shaft 38 of the actuator 30 is brought into the installation hole 11 from the recess portion 50 side, and then the actuator 30 is moved (swung) in the direction of arrow B in FIG. 2 so as to push the pivot portion 39 at the end of the actuation shaft 38 into the bearing 37, thus allowing the pivot portion 39 to be supported by the bearing 37. Thereafter, the actuator housing 31 is fixed to the installation hole 11 by appropriate fixing means such as a screw fastening. As a result, the actuator 30 fixed to the installation hole 11 and the light source unit 20 (the reflector 21) are coupled together at the aiming support point A₁ that is constituted by the pivot portion 39 engaged with the bearing 37.

On the other hand, when the actuator 30 is to be removed, it can be easily done by first removing the front cover 12, then releasing the actuator housing 31 from the installation hole 11, and holding the light source unit 20 (the reflector 21) by pressing it by, for example, the left hand, and moving (swinging) the actuator 30 in the direction of arrow C in FIG. 2 so as to disengage the pivot portion 39 of the actuation shaft 38 from the bearing 37, and then taking out the actuation shaft 38 of the actuator 30 from the inner side of the installation hole 11.

In the shown embodiment, the recess portion 50 is formed so that its longitudinal length is sufficiently large so that the actuator 30 can be easily attached to and detached from the installation hole 11.

Since the recess portion 50 is in the bottom side of the lamp body 10, the recess portion 50 forms an undercut portion at the time of performing injection molding of the lamp body 10. Accordingly, a circular opening 10b is formed in the vertical wall 52 that has the actuator installation hole 11 and another circular opening 10c is formed in the lamp body's back wall that faces the vertical wall 52. The circular opening 10b is closed by the vertical wall 52 with a seal member 53a in between, and the circular opening 10c is sealed, via a seal member 54a, with a back cover 54.

The reference numeral 13 is an extension reflector. The extension reflector 13 has in its center area an opening (a circular hole) 13a that allows the front end portion of the light source unit 20 to be inserted therethrough, and an aluminum vapor deposition treatment is applied to the surface of this extension reflector 13. The extension reflector 13 is provided along the inner side of the front cover 12 and covers the periphery of the light source unit 20, and it makes the whole inner side of the lamp chamber S appear in a specular manner. With this extension reflector 13, the recess portion 50 protruding (evaginating) into the lamp chamber S is absolutely invisible from the front of the lamp.

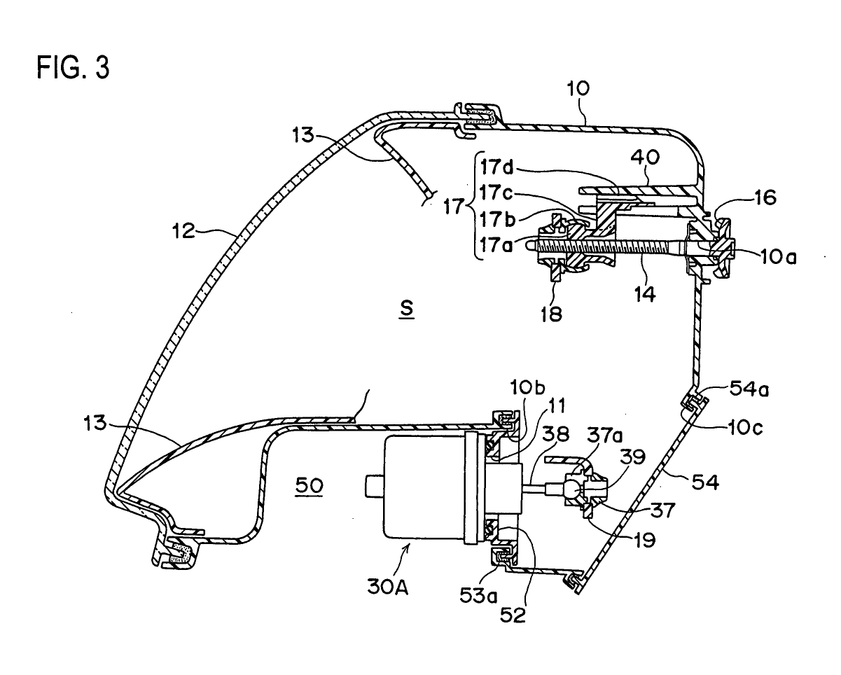

The actuator 30 is provided so that its actuation shaft 38 is, as seen from FIG. 2, orthogonal to the output shaft 32 of the motor; however, as shown in FIG. 3, the actuation shaft 38 can be set to be coaxial with the output shaft 32 of the motor.

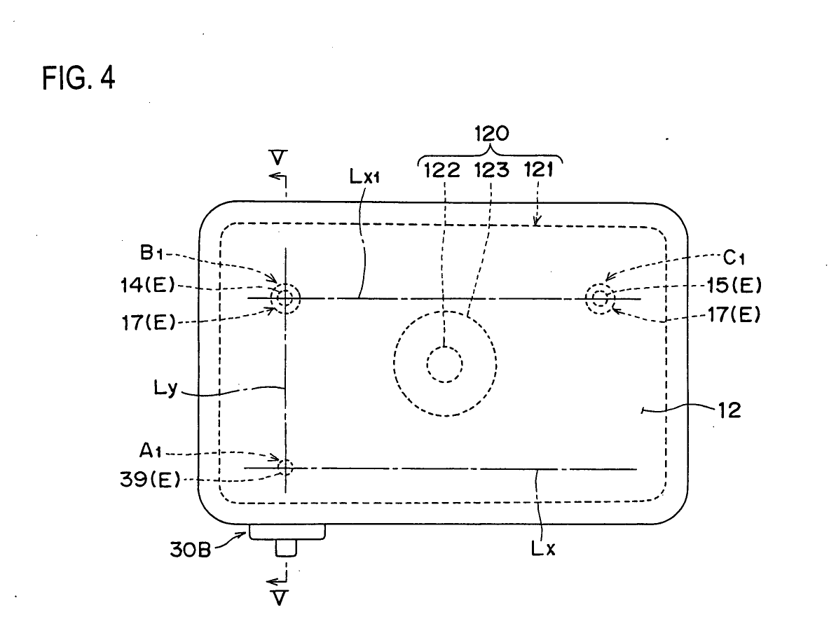

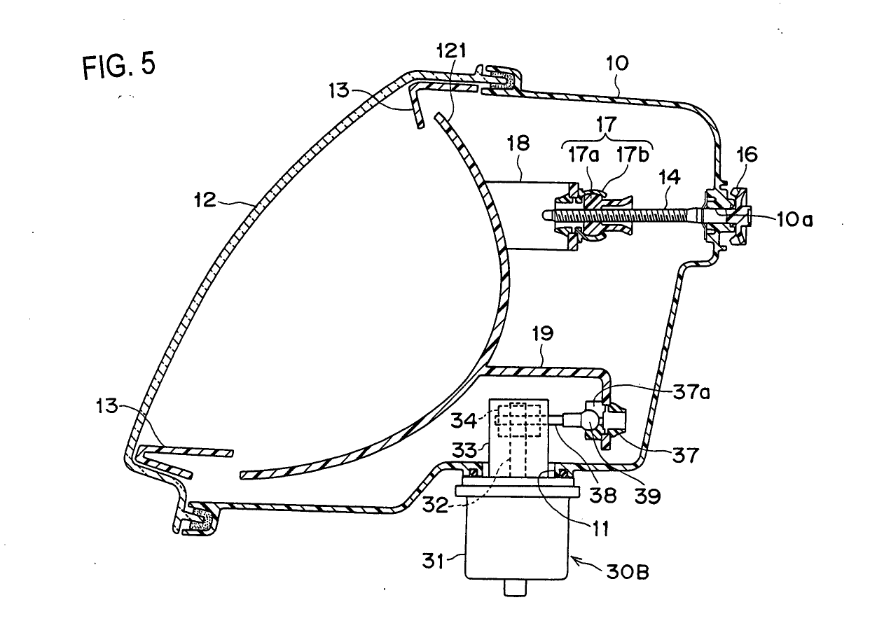

FIGS. 4 and 5 show the headlamp for an automobile in accordance with the second embodiment of the present invention. FIG. 4 shows the front face of the headlamp, and FIG. 5 shows the inside of the headlamp.

In the first embodiment described above, the projection type light source unit 20 inside the lamp chamber S is supported by the aiming mechanism E in a tiltable fashion. In the embodiment of FIGS. 4 and 5, a reflection type light source unit 120 is tiltably supported inside the lamp chamber S by the aiming mechanism E. The reflection type light source unit 120 includes a halogen bulb 122 which is the light source and is provided in the rear top portion of a reflector 121 that is formed in a substantially paraboloidal shape.

An aluminum vapor deposition treatment is applied to the surface of the reflector 121, and a stepped effective reflecting surface (not shown) is provided in a predetermined area of the reflector's surface. A light distribution forming shade 123 that shields light going to the other areas than the effective reflecting surface of the reflector 121 from the bulb 122 is provided in the front side of the bulb 122 and fixed to the reflector 121. The light from the bulb 122 is reflected by the effective reflecting surface of the reflector 121 and distributed to the front side through the front cover 12, thus forming a low beam, which has a predetermined clear cut line, in front of the vehicle.

In the same manner as in the first embodiment described above, the light source unit 120 (the reflector 121) is supported by three points comprised of a pair of aiming points B₁ and C₁, which are apart from each other in the lateral direction, and one aiming support point A₁, which is positioned just below the aiming point B₁; and thus, the light source unit 120 (the reflector 121) is tiltable by aiming mechanism E described below around each of the horizontal tilt axis Lx and the vertical tilt axis Ly. Here, the horizontal tilt axis Lx is parallel to the axis Lx₁, which passes through the aiming points B₁ and C₁, and passes through the aiming support point A₁, and the vertical tilt axis Ly passes through the aiming points B₁ and A₁.

In the second embodiment, the reflection type light source unit 120 is lighter than the projection type light source unit 20 that includes the projection lens 24 which is heavy. Accordingly, the weight load applied to the aiming mechanism E is small; and a reinforcing mechanism for the aiming mechanism E such as the T-shaped slide arm 17c that supports the tip end portions of the aiming screws 14 and 15 in a suspending manner and the dovetail groove guide 40 is not employed.

Further, the actuator installation hole 11 is provided in the bottom surface wall of the lamp body 10, and the actuator 30B is inserted and fixed to the installation hole 11 from the lower side or from the bottom. In this actuator 30B, the power transmission section 33, which coaxially transmits the rotational drive of the output shaft 32 of the motor, and the actuation shaft 38, which moves forward and backward by the transmitted rotational drive of the output shaft 32, form a substantially L shape above the actuator housing 31 that has the motor therein.

When the output shaft 32 is rotated, the actuation shaft 38 is moved forward and backward via a gear mechanism 34 that is formed by a worm, a worm wheel and the like.

The power transmission section 33 protrudes above the installation hole 11, and the actuation shaft 38 extends to the rear side from the side of the end portion of the power transmission section 33; and the pivot portion 39 at the end of the actuation shaft 38 is coupled to the bearing 37 of the bracket 19 of the reflector 121.

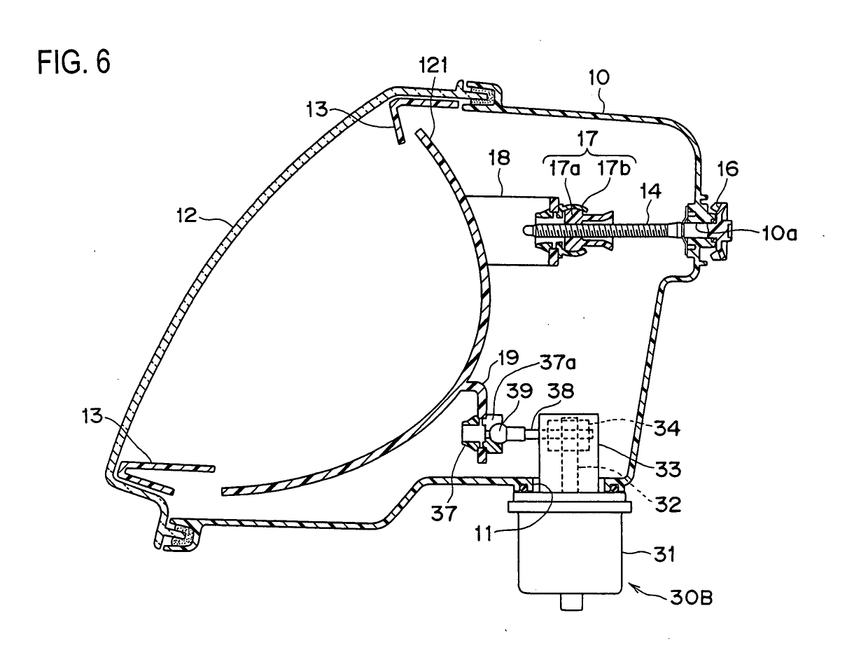

In the second embodiment, the actuator 30B is installed so that the actuation shaft 38 extends toward the rear inside the lamp chamber S. However, as shown in FIG. 6, the actuator 30B can be provided so that its actuation shaft 38 extends toward the front inside the lamp chamber S.

As is apparent from the description above, in accordance with the headlamp for an automobile of the present invention, the depth of the headlamp is smaller to the degree that the leveling actuator does not protrude to the back of the lamp body, and thus it is possible to make the headlamp thinner or have a smaller depth.

In addition, since the leveling actuator is provided in the bottom of the lamp body, and since it does not largely protrude to the bottom the lamp body, the actuator does not interfere with parts in the vehicle body, and it is possible to make the headlamp smaller in the vertical direction as well.

Furthermore, the amount the leveling actuator protrudes into the lamp chamber is small and does not cause a hindrance to the functions of other parts; and since it is easy to attach and detach the leveling actuator, the leveling actuator can be replaced easily.

1. A headlamp for an automobile comprising:
a container-shaped lamp body forming a lamp chamber in cooperation with a front cover provided on a front opening of said lamp body;
a reflector having a light source therein and provided so as to be freely tilt around a predetermined horizontal tilt axis disposed in an inside upper portion of said lamp chamber; and
a leveling actuator which is installed from an outside of said lamp body in an installation hole provided in the lamp body and includes an actuation shaft which is movable forward and backward and is connected, within said lamp chamber, to said reflector; wherein
said leveling actuator is provided in a bottom portion of said lamp body.

2. The headlamp for an automobile according to claim 1, wherein:
said lamp body is formed in a bottom wall thereof with a recess portion that inwardly protrudes and accommodates therein said leveling actuator,
said installation hole is provided in a laterally extending substantially vertical wall of said recess portion, and
said leveling actuator is provided in said installation hole from said recess portion side such that an actuation shaft thereof extends to a rear side within said lamp chamber.

3. The headlamp for an automobile according to claim 1, wherein
said installation hole is provided in a bottom wall of said lamp body; and
said leveling actuator is provided in said installation hole from a lower side of said lamp body so that an actuation force transmission member thereof and an actuation shaft thereof protrude above said installation hole in a substantially L shape, and said actuation shaft extends in a forward direction of inside said lamp chamber.

4. The headlamp for an automobile according to claim 1, wherein
said installation hole is provided in a bottom wall of said lamp body; and
said leveling actuator is provided in said installation hole from a lower side of said lamp body so that an actuation force transmission member thereof and an actuation shaft thereof protrude above said installation hole in a substantially L shape, and said actuation shaft extends in a rearward direction of inside said lamp chamber.
